(19) United States
(12) Patent Application Publication
(10) Pub. No.: US 2009/0244024 A1
(43) Pub. Date: Oct. 1, 2009

(54) DISPLAY DEVICE WITH TOUCH PANEL AND A METHOD FOR MANUFACTURING THE SAME

(75) Inventor: Yoshitaka Kurahashi, Inazawa-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/410,056

(22) Filed: Mar. 24, 2009

(30) Foreign Application Priority Data
Mar. 26, 2008 (JP) 2008081226

(51) Int. Cl. G06F 3/041

(52) U.S. Cl. 345/173

(57) ABSTRACT

There is provided a display device with a touch panel and a method for manufacturing the same, the display device with the touch panel that has a display 20 having a surface on which the touch panel 10 is provided, wherein in the touch panel transparent conductive layers 11a, 12a are oppositely arranged each other to form a contact, including: a rough-surfaced coating layer 21 that is provided on the display 20 and forms a micro-roughed surface; and a damage-protection coating layer 16 that is provided on the bottom surface of the touch panel 10 and has almost the same hardness with the rough-surfaced coating layer 21, wherein the touch panel 10 is laminated onto the surface of the display 20 so that it is possible to improve the displaying characteristics, to come down in thickness of the display device, and to improve the reliability.

### BACKGROUND OF THE INVENTION

1. Field of the Invention

The present invention relates to a display device with a touch panel in which the touch panel such as a matrix switch and the like is provided on a surface of a display. In particular, the present invention relates to a display device with a touch panel in which the bottom surface of the touch panel and a surface of a display are not optically adhered to each other, but come into contact with each other near-uniformly to improve image quality, thickness, and reliability of the touch panel display. Further, the present invention relates to a method for manufacturing such the touch panel display.

2. Description of the Related Arts

Display devices with respective touch panels have been widely used as an input device of electronics devices, for example, portable information terminals, mobile phones, copy machines, fax machines, bank's automatic teller machines (ATM) and the like. Referring to FIGS. 5-7, several conventional touch panel displays will be explained below.

FIG. 5 is a cross sectional view illustrating a display device with a touch panel according to a first conventional example. In FIG. 5, the display device with the touch panel is configured such that the touch panel 110 and a surface of a display 120 are adhered to each other via a seal member 130.

The touch panel 110 has been accepted to have a so-called film-film-plastic (FFP) structure in which two transparent insulating films 111, 112 and a film supporting member 115 are laminated. Individual transparent conductive membranes 111a, 112a are formed on respective opposite surfaces of the transparent insulating films 111, 112. The transparent insulating films 111, 112 are arranged to have a predetermined spacing having a predetermined length between them by adhering outer peripheries of the transparent insulating films 111, 112 to each other via a seal member 114 which has a predetermined thickness. Many spacers 113, 113, 113, . . . are interposed between the transparent insulating films 111, 112 to keep the predetermined spacing between the transparent conductive membranes 111a, 112a constant.

Outer periphery of the bottom surface of such the touch panel 110 is adhered to a surface of a display 120 via a seal member 130 having a thickness of about 0.3 to 0.5 mm so that it has been ensured to have a clearance CL having the same thickness with that of the seal member 130 between the touch panel 110 and the display 120.

Next, FIG. 6 is a cross sectional view illustrating a display device with a touch panel according to a second conventional example. The touch panel 110 of a display device with the touch panel 102 shown in FIG. 6, has been accepted to have a so-called film-glass (FG) structure in which the transparent insulating film 111 and a glass substrate 116 are laminated. The transparent conductive membrane 112a is formed on a surface of the glass substrate 116 to omit the lower transparent insulating film 112 and the film supporting member 115 which are shown in FIG. 5. In this second example similar to the first example, it has been ensured to have a clearance CL having the same thickness with that of the seal member 130 between the touch panel 110 and the display 120.

Meanwhile, with regard to the first and second conventional examples as mentioned above, if structures of the display devices with the touch panel 101, 102 are configured such that the touch panel 110 would directly laminate on the surface of the display 120 without the clearance CL, a first portion where the bottom surface of the touch panel 110 and the surface of the display 120 are optically adhered to each other and a second portion where the bottom surface of the touch panel 110 and the surface of the display 120 are not optically adhered to each other and thus some gap between them is formed may be created. That's because there inevitably exists small deformations of the bottom surface of the touch panel 110 and the surface of the display 120. In general, the optically adhesion means a connection of two optical surfaces that inhibits any air gap to be formed between them.

If the first portion where the bottom surface of the touch panel 110 and the surface of the display 120 are optically adhered to each other may form an optically adhered region which has an area being visual size, there is a sufficient difference between a first optical path traveling across the optically adhered region and a second optical path traveling across a separated region extending outside the optically adhered region so that the display devices may display a non-uniform image. In order to prevent such the optically adhered region from being formed, in the display devices with the touch panel 101, 102 according to the first and second conventional examples, the clearance CL has been formed between the bottom surface of the touch panel 110 and the surface of the display 120.

Finally, FIG. 7 is a cross sectional view illustrating a display device with the touch panel according to a third conventional example. The display device with the touch panel 103 shown in FIG. 7 has a structure in which the whole bottom surface of the touch panel 110 and the surface of the display 120 are optically adhered to each other via an adhesive sheet 140.
[Patent citation 1] Japanese Patent Laid-Open 2005-346047 (FIGS. 1, 5, and 8˜10)
[Patent Citation 2] Japanese Patent Laid-Open 2005-345799 (FIGS. 7 and 8)

However, in the display devices with the touch panel 101, 102 according to the first and second conventional examples, it is difficult to keep the clearance CL between the bottom surface of the touch panel 110 and the surface of the display 120 constant over the whole bottom surface of the panel. Even if the clearance CL would be formed, the optically adhered region would be partially created due to deflection or deformation of the film supporting member 115, the glass substrate 116, or the display 120, the deflection or deformation being caused while using the display devices, and therefore a trouble in which the display devices may display a non-uniform image may be occurred.

Meanwhile, in the display device with the touch panel 103 according to the third conventional example, because the whole bottom surface of the touch panel 110 and the surface of the display 120 are optically adhered to each other via an adhesive sheet 140, the adhesive sheet 140 may be yellowed, or a bubble may be created from a gas emitted from the adhesive sheet 140 when a side 120 of the display is heated to high temperature. This results in a trouble in which image quality of the display device is deteriorated. Further, if a dust would be touched to the adhesive sheet 140 during manufacturing process, it may be difficult to rework the touch panel 110 and the display 120, so that a problem in which the yield of admitted production becomes a low value may be caused.

Further, in the display devices with the touch panel 101, 102 according to the first and second conventional examples, because there is needed to ensure that the clearance has the thickness of about 0.3 to 0.5 mm, it is difficult to come down in thickness of the display device. Further, even in the display device with the touch panel 103 according to the third conventional example, there has been a problem in which it is difficult to come down in thickness of the display device because the adhesive sheet 140 has almost the same thickness with the clearance CL. Hence, there has been a problem in which it is also difficult to come down in thickness of electronics with one of the display devices 101-103.

### SUMMARY OF THE INVENTION

The present invention has been performed to solve the above mentioned status and problems and an object of the present invention is to provide a display device with a touch panel and a method for manufacturing the same which prevent an optically adhered region between the bottom surface of the touch panel and a surface of a display from occurring so as to improve the image quality, to come down in thickness of the display device, and to improve the reliability.

A display device with a touch panel according to the present invention, which has a display having a surface on which the touch panel is provided, wherein in the touch panel transparent conductive layers are oppositely arranged each other to form a contact, includes: a rough-surfaced coating layer that is provided on the display and forms a micro-roughed surface; and a damage-protection coating layer that is provided on the bottom surface of the touch panel and has almost the same hardness with the rough-surfaced coating layer, wherein the touch panel is laminated or accumulated onto the surface of the display so that the rough-surfaced coating layer and the damage-protection coating layer are in contact with each other.

Further, a method for manufacturing a display device with a touch panel that has a display having a surface on which the touch panel is provided, wherein in the touch panel transparent conductive layers are oppositely arranged each other to form a contact, includes steps of: providing a rough-surfaced coating layer on the display and forms a micro-roughed surface; providing a damage-protection coating layer on the bottom surface of the touch panel, the damage-protection coating layer having almost the same hardness with the rough-surfaced coating layer; and laminating or accumulating the touch panel onto the surface of the display so that the rough-surfaced coating layer and the damage-protection coating layer are in contact with each other.

### BRIEF DESCRIPTION OF THE DRAWINGS

FIG. 1 is a cross sectional view illustrating a touch panel and a display of which a display device with the touch panel according to a first embodiment of the present invention is constituted;

FIG. 2 is a cross sectional view illustrating the display device with the touch panel according to the first embodiment after the touch panel has been laminated and fixed to the display;

FIG. 3 is a cross sectional view illustrating a structure of a display device with a touch panel according to a second embodiment of the present invention;

FIG. 4 is a cross sectional view illustrating a structure of a display device with a touch panel according to a third embodiment of the present invention;

FIG. 5 is a cross sectional view illustrating a display device with a touch panel according to a first conventional example;

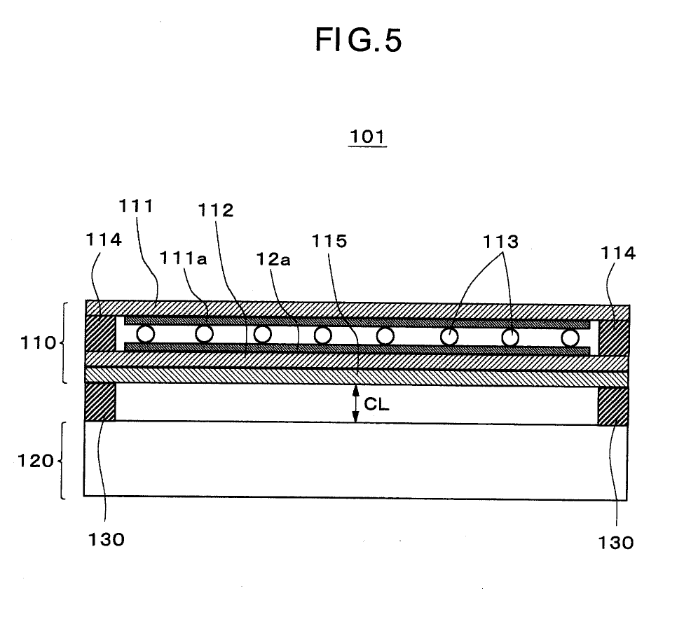

FIG. 6 is a cross sectional view illustrating a display device with a touch panel according to a second conventional example; and

FIG. 7 is a cross sectional view illustrating a display device with a touch panel according to a third conventional example.

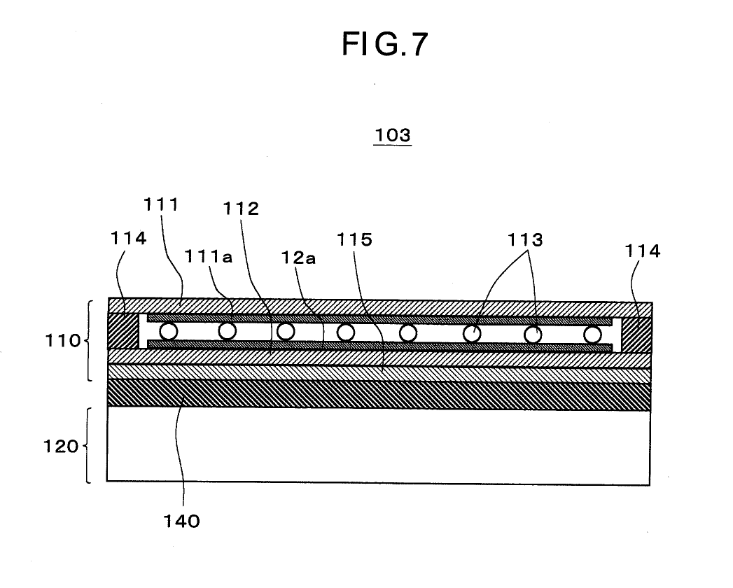

### DETAILED DESCRIPTION OF THE PREFERRED EMBODIMENTS

### General Description

In order to reach the above mentioned object, a display device with a touch panel according to the present invention, which has a display having a surface on which the touch panel is provided, wherein in the touch panel transparent conductive layers are oppositely arranged each other to form a contact, includes: a rough-surfaced coating layer that is provided on the display and forms a micro-roughed surface; and a damage-protection coating layer that is provided on the bottom surface of the touch panel and has almost the same hardness with the rough-surfaced coating layer, wherein the touch panel is laminated or accumulated onto the surface of the display so that the rough-surfaced coating layer and the damage-protection coating layer are in contact with each other.

In such the configuration in which the rough-surfaced coating layer is provided on the surface of the display, because the micro-roughed surface of the rough-surfaced coating layer comes in contact with and support the bottom surface of the touch panel via uniformly scattered point contacts, it is possible to prevent an optically adhered region from being formed between the surface of the display and the bottom surface of the touch panel effectively.

Besides, it can theoretically be seen that concave portions of which the rough-surfaced coating layer is partially constituted come in contact with and optically adhered to the damage-protection coating layer via the point contacts. However, in contrast to the case where one surface and another surface come in contact with each other to form a continuous optically adhered region, there is no influence on image quality of the display device.

Further, as mentioned above, when the micro-roughed surface of the rough-surfaced coating layer comes in contact with the bottom surface of the touch panel directly, because there is a difference between values of hardness of the bottom surface of the touch panel and the micro-roughed surface of the rough-surfaced coating layer, one of them may be abraded or damaged due to vibration or shock caused in manufacturing process or during transport time, and therefore a trouble in which the image quality of the display device is deteriorated may occur. To resolve this trouble, the damage-protection coating layer having almost the same hardness with the rough-surfaced coating layer is provided on the bottom surface of the touch panel to reduce the difference between values of hardness of the bottom surface of the touch panel and the micro-roughed surface of the rough-surfaced coating layer. Therefore, it is possible to prevent both of the bottom surface of the touch panel and the rough-surfaced coating layer from being abraded or damaged.

According to such the configuration, it is possible to realize the display device with the touch panel which prevents the optically adhered region from occurring between the bottom surface of the touch panel and the surface of the display so as to improve the image quality, to come down in thickness of the display device, and to improve the reliability.

The “rough-surfaced coating layer” according to the present invention can be allowed to be any type of layers which can support the bottom surface of the touch panel via the point contacts, such as either one which includes a micro-roughed surface made of a coating material with which fine particles are mixed, or another which includes a coating member having a surface which is micro-roughed. Further, any hard coats made of plastic or plastic composite material for commercial purpose can be used as the “damage-protection coating layer” because they have sufficient hardness. Further, it is preferable that the hardness of the damage-protection coating layer is equal to that of the rough-surfaced coating layer from the view point of preventing the damage-protection coating layer from being damaged. However, in actually, it may be allowed that there is a slight difference between the values of hardness of the bottom surface of the touch panel and the micro-roughed surface of the rough-surfaced coating layer such that the difference results in no bad influence on the image quality of the display device.

Further, the present invention relates to a contact structure between the bottom surface of the touch panel and the micro-roughed surface of the rough-surfaced coating layer, and is widely applicable to many types of touch panel and display. It may be applicable that the “touch panel” employs any one of a matrix switching system in which either physical contact is utilized or not, a resistance film system, a surface elastic wave system, and the like. The “display” can be of any type of display including cathode ray tube (CRT) display, liquid crystal display, electrophoretic display, and the like. Further, because the present invention adopts the structure in which the bottom surface of the touch panel comes in contact with the surface of the display directly, when the matrix switching system which utilizes the physical contact would be employed, it may be preferable that the electrophoretic display is used as the display so as to prevent image from smearing upon applied pressure.

It is preferable that in the above mentioned display device with the touch panel according to the present invention, the damage-protection coating layer has hardness harder than that of the rough-surfaced coating layer.

As discussed above, although it is preferable that the hardness of the damage-protection coating layer is equal to that of the rough-surfaced coating layer from the view point of preventing the damage-protection coating layer from being damaged, when the hardness of the damage-protection coating layer is greater than that of the rough-surfaced coating layer, it can be ensured that the damage-protection coating layer protects the bottom surface of the touch panel from being abraded or damaged. In contrast to this, even when the micro-roughed surface of the rough-surfaced coating layer is abraded or damaged, it is ensured to prevent an optically adhered region from being formed between the surface of the display and the bottom surface of the touch panel unless the micro-roughed surface becomes flat.

It is preferable that both of the rough-surfaced coating film and the damage-protection coating layer are configured to have hardness 3 H in accordance with the Japanese Industrial Standard. It is more preferable that the rough-surfaced coating layer is configured to serve as a glare proof coating layer in which the micro-roughed surface diffusively reflects incident light entering into the display.

According to such the configurations, when the glare proof coating layer which is made for commercial purpose is used as the rough-surfaced coating layer, in addition to the above mentioned advantages, it is possible to reduce screen glace and reflections from the screen. Further, when both of the rough-surfaced coating film and the damage-protection coating layer are configured to have hardness 3 H in accordance with the Japanese Industrial Standard, it is possible to prevent them from being abraded or damaged by coming into contact with each other.

In order to reach the above mentioned object, a method for manufacturing a display device with a touch panel that has a display having a surface on which the touch panel is provided, wherein in the touch panel transparent conductive layers are oppositely arranged each other to form a contact, includes steps of: providing a rough-surfaced coating layer on the display and forms a micro-roughed surface; providing a damage-protection coating layer on the bottom surface of the touch panel, the damage-protection coating layer having almost the same hardness with the rough-surfaced coating layer; and laminating or accumulating the touch panel onto the surface of the display so that the rough-surfaced coating layer and the damage-protection coating layer are in contact with each other.

According to such the method, similar to the above discussions, it is possible to provide a method for manufacturing the display device with the touch panel, the method preventing the optically adhered region between the bottom surface of the touch panel and the surface of the display from occurring so as to improve the image quality, to come down in thickness of the display device, and to improve the reliability.

### Advantageous Effects

In the display device with the touch panel and the method for manufacturing the same according to the present invention, it is possible to prevent the optically adhered region between the bottom surface of the touch panel and the surface of the display from occurring so as to improve the image quality, to come down in thickness of the display device, and to improve the reliability.

### FIRST EMBODIMENT

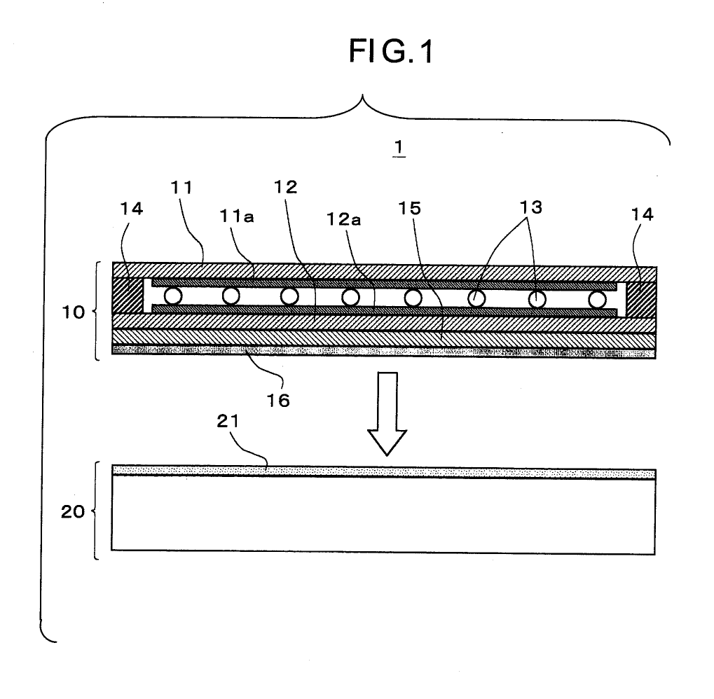

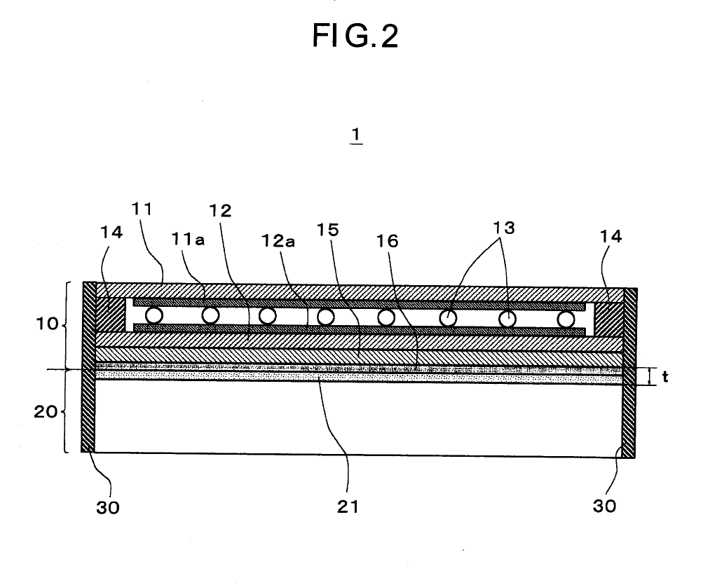

Referring to FIGS. 1 and 2, a display device with a touch panel and a method for manufacturing the same according to the present invention will be explained below. FIG. 1 is a cross sectional view illustrating the touch panel and a display of which the display device with the touch panel according to a first embodiment of the present invention is constituted. FIG. 2 is a cross sectional view illustrating the display device with the touch panel according to the first embodiment after the touch panel is laminated and fixed to the display.

In FIG. 1, the touch panel 10 has a film-film-plastic (FFP) structure in which two transparent insulating films 11, 12 and a film supporting member 15 that supports the two transparent insulating films are laminated. Material of which two transparent insulating films 11, 12 are made is exemplified by transparent resin film such as polyethylene terephthalate (PET), poly carbonate (PC), poly ehter sulphone (PES), polyarylate (PAR), cyclic polyolefin, and the like.

Individual transparent conductive membranes 11a, 12a are formed on respective opposite surfaces of the transparent insulating films 11, 12 to make stripe arrangement. Each of the transparent conductive membranes 11a, 12a works as a film-shaped resistor made of, for example, metal oxide such as indium tin oxide (ITO) and the like, or metal such as copper, tin, nickel, and the life, and is formed by vacuum evaporation technique or spattering technique.

The transparent insulating films 11, 12 are arranged to have a predetermined spacing having a predetermined length by adhering outer peripheries of the transparent insulating films 11, 12 to each other via a seal member 14 which has a predetermined thickness. Many spacers 13, 13, 13, . . . are interposed between the transparent insulating films 11, 12 to keep the predetermined spacing between the transparent conductive membranes 11a, 12a constant. These spacers 13 are fine point-like bodies made of transparent resin material, and are formed on the upper transparent conductive membranes 11a or the lower transparent conductive membranes 12a by screen printing technique.

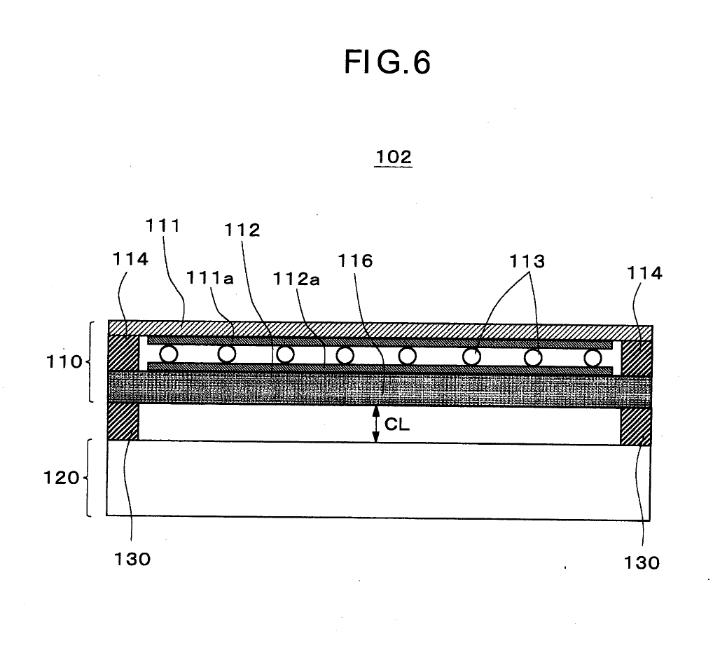

The film supporting member 15 is a member that supports the two transparent insulating films 11, 12, and can be made of, for example, poly carbonate (PC), Polymethyl methacrylate (PMMA), and the like. Further, it is allowed that the touch panel 10 is configured to have, instead of providing the transparent insulating film 12 and the film supporting member 15, a glass substrate having a surface on which the transparent conductive membrane 12a is formed (see FIG. 6).

The underside of the film supporting member 15 is coated by the damage-protection coating layer 16. This damage-protection coating layer 16 is made of plastic or plastic composite material, for example, acrylic resin, silicone resin, ultra-violet (UV) curing resin, and the like, and is configured to have the same hardness with that of a rough-surfaced coating layer 21 which is laminated on a surface of a display 20, as to be discussed below. In the present embodiment, values of hardness of both of the damage-protection coating layer 16 and the rough-surfaced coating layer 21 are adjusted to 3 H according to the pencil hardness to prevent both of the rough-surfaced coating layer 21 and the underside of the film supporting member 15 from being abraded or damaged. Such the damage-protection coating layer 16 can be formed by coating a predetermined plastic material on the underside of the film supporting member 15 directly, or by gluing a film made of the same material on the underside of the film supporting member 15.

Further, in the present embodiment, the values of hardness of both of the damage-protection coating layer 16 and the rough-surfaced coating layer 21 are adjusted to 3 H according to the pencil hardness. However, the values of hardness are not limited to 3 H unless both of the damage-protection coating layer 16 and the rough-surfaced coating layer 21 have substantially the same value. This is because, when the rough-surfaced coating layer 21 and the underside of the film supporting member 15 have substantially the same value of hardness, it is possible to prevent them from being abraded or damaged. When the rough-surfaced coating layer 21 is adjusted to 3 H according to the pencil hardness, the damage-protection coating layer 16 is allowed to have not only value 3 H of hardness, but also values of hardness of 2 H and 4 H which are neighbors to 3 H. A difference of about ±1 in hardness has almost no influence on the image quality of the display device, even when the rough-surfaced coating layer 21 and the underside of the film supporting member 15 are abraded or damaged. However, when hardness is expressed according to Moh's hardness, because change in hardness is not linearly proportional to change in value of hardness, in particular, changes in hardness between values 1 and 2 and between 9 and 10 are relatively large in comparison with other intervals, it should be noted that there may be a case where difference about ±1 in vale of hardness does not result in substantially the same hardness.

As discussed above, it is preferable that the hardness of the damage-protection coating layer 16 is equal to that of the rough-surfaced coating layer 21 from the view point of preventing the damage-protection coating layer 16 from being damaged. However, it is allowed that the hardness of the damage-protection coating layer 16 is greater than that of the rough-surfaced coating layer 21. When the hardness of the damage-protection coating layer 16 is greater than that of the rough-surfaced coating layer 21, it is ensured to prevent the bottom surface of the touch panel 10 from being abraded or damaged due to existence of the damage-protection coating layer 16. In contrast to this, even when the micro-roughed surface of the rough-surfaced coating layer 21 is abraded or damaged, it is ensured to prevent the optically adhered region from being formed between the surface of the display 20 and the bottom surface of the touch panel 10 unless the micro-roughed surface becomes flat.

The display 20 can be any one of types including cathode ray tube (CRT) display, liquid crystal display, electrophoretic display, and the like, and the surface of the display 20 is coated with the above mentioned rough-surfaced coating layer 21. The rough-surfaced coating layer 21 includes a micro-roughed surface over the whole surface of the rough-surfaced coating layer 21. The micro-roughed surface is formed by, for example, mixing transparent fine particles such as beads of acrylic resion with material of plastic or plastic compound of which the above mentioned damage-protection coating layer 16 is made.

Here, it is preferable that roughness of the micro-roughed surface of the rough-surfaced coating layer 21 has a value within a range between about 0.2 and 30 according to the Haze value which estimates transparency. When the Haze value is smaller than 0.2, that is, in the case where nearly a transparent condition is realized, the rough-surfaced coating layer 21 has nearly a flat surface which is not micro-roughed so that the rough-surfaced coating layer 21 has only a small effect to prevent the optically adhered region from being formed. In contrast to this, when the Haze value is greater than 30, that is, in the case where nearly opaque condition is realized, the transparency of the display 20 is reduced to result in bad influence on the image quality of the display device.

Such the rough-surfaced coating layer 21 can be formed by coating a predetermined plastic or plastic compound into which fine particles are mixed on the surface of the display 20, or by adhering a film of the same material on the surface of the display 20. Further, it is allowed that the rough-surfaced coating layer 21 serves as a glare proof coating layer in which the micro-roughed surface diffusively reflects incident light entering into the display 20.

In FIG. 2, the touch panel 10 configured to have the above mentioned structure is laminated on the display 20 such that the damage-protection coating layer 16 and the rough-surfaced coating layer 21 come into contact with each other. Further, the outer peripheries of the damage-protection coating layer 16 and the rough-surfaced coating layer 21 are fixed by a tape 30 to form the display device with the touch panel 1 according to the present embodiment. In the present embodiment, a total thickness t which is obtained by summing up those of the damage-protection coating layer 16 and the rough-surfaced coating layer 21 may reach to several ten μm.

According to the display device with the touch panel 1 and the method for manufacturing the same according to the present embodiment, because the rough-surfaced coating layer 21 is provided on the surface of the display 20 and the rough-surfaced coating layer 21 supports the bottom surface of the touch panel 10 via uniformly scattered point contacts, it is possible to prevent an optically adhered region from being formed between the surface of the display and the bottom surface of the touch panel effectively.

Further, the damage-protection coating layer 16 having almost the same hardness with the rough-surfaced coating layer 21 is provided on the bottom surface of the touch panel 10 to reduce the difference between values of hardness of the bottom surface of the touch panel 10 and the micro-roughed surface of the rough-surfaced coating layer 21. Therefore, it is possible to prevent both of the bottom surface of the touch panel 10 and the rough-surfaced coating layer 21 from being abraded or damaged.

According to such the configuration, it is possible to realize the display device with the touch panel 1 which prevents the optically adhered region from occurring between the bottom surface of the touch panel 10 and the surface of the display 20 so as to improve the image quality, to come down in thickness of the display device, and to improve the reliability.

In the display devices with the touch panel 101, 102 according to the first and second conventional examples, the clearance CL formed between the bottom surface of the touch panel 110 and the surface of the display 120 has length of about 0.3 to 0.5 mm. However, in particular, it is possible to reduce the total thickness t of the damage-protection coating layer 16 and the rough-surfaced coating layer 21 to several ten μm which is smaller than the clearance CL formed between the bottom surface of the touch panel 10 and the surface of the display 20. Therefore, it is possible to come down in thickness of the display device with the touch panel 1 drastically.

Further, when the glare proof coating layer which is made for commercial purpose is used as the rough-surfaced coating layer, it is possible to reduce screen glace and reflections from the screen.

Further, the display device with the touch panel 1 and the method for manufacturing the same according to the present invention is not limited to those according to the above mentioned embodiment. For example, in contrast to the present embodiment in which the matrix switch in which physical contact is utilized is used as the touch panel 10, it is allowed that the touch panel 10 uses a non-contact type matrix switch in which optical change or small change in static electric current is detected. The display 10 can be any one of types including cathode ray tube (CRT) display, liquid crystal display, electrophoretic display, and the like which are other than matrix switches.

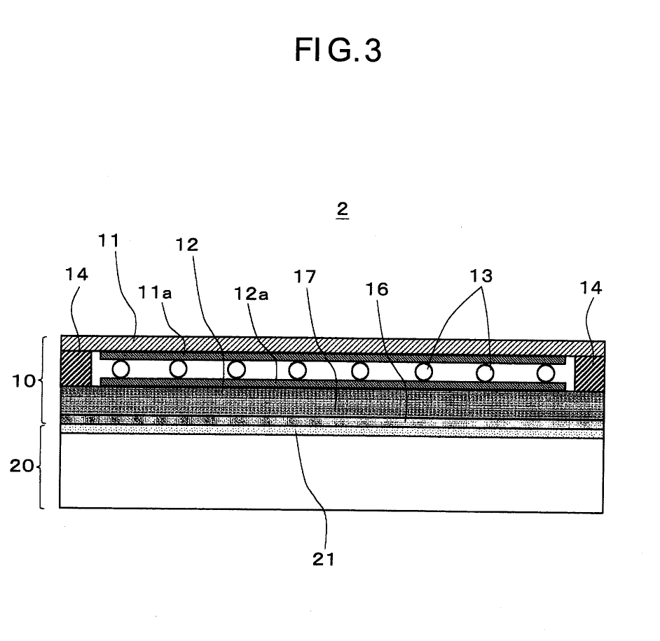

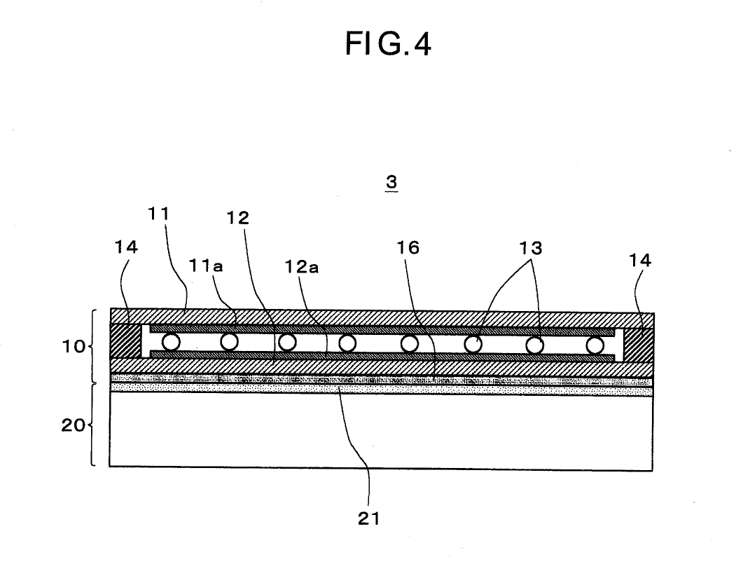

Further, the touch panel 10 according to the first embodiment discussed above, has a film-film-plastic (FFP) structure in which two transparent insulating films 11, 12 and a film supporting member 15 are laminated. However, the touch panel 10 should not be limited to have such the structure, and the present invention can be applicable to a display device with a touch panel in which the touch panel has a film-glass (FG) structure as shown in FIG. 3, and to another display device with a touch panel in which the touch panel has a film-film (FF) structure as shown in FIG. 4.

### SECOND EMBODIMENT

FIG. 3 is a cross sectional view illustrating a structure of a display device with a touch panel according to a second embodiment of the present invention. In FIG. 3, the display device with the touch panel 2 includes the touch panel 10 having a structure in which the transparent insulating film 11 and the glass substrate 17 are laminated. The damage-protection coating layer 16 is coated on the bottom surface of the glass substrate 17. The rough-surfaced coating layer 21 is coated on the surface of the display 20. Because the touch panel 10 has the FG structure, the transparent insulating film 12 and the film supporting member 15 are omitted.

### THIRD EMBODIMENT

FIG. 4 is a cross sectional view illustrating a structure of a display device with a touch panel according to a third embodiment of the present invention. In FIG. 4, the display device with the touch panel 3 includes the touch panel 10 having a structure in which only the two transparent insulating films 11, 12 are laminated while the film supporting member 15 shown in FIGS. 1 and 2 is omitted. The damage-protection coating layer 16 is coated on the underside of the transparent insulating films 12 of the touch panel 10. The rough-surfaced coating layer 21 is coated on the surface of the display 20.

As discussed above, even when the touch panel 10 has the film-glass (FG) or film-film (FF) structures, the damage-protection coating layer 16 and the rough-surfaced coating layer 21 can be inserted between the bottom surface of the touch panel 10 and the surface of the display 20 to prevent an optically adhered region from being formed therebetween. As a result of this, it is possible to improve the image quality, to come down in thickness of the display device, and to improve the reliability.

1. A display device with a touch panel that has a display having a surface on which the touch panel is provided, wherein in the touch panel transparent conductive layers are oppositely arranged each other to form a contact, comprising:
a rough-surfaced coating layer that is provided on the display and forms a micro-roughed surface; and
a damage-protection coating layer that is provided on the bottom surface of the touch panel and has almost the same hardness with the rough-surfaced coating layer, wherein the touch panel is laminated onto the surface of the display so that the rough-surfaced coating layer and the damage-protection coating layer are in contact with each other.

2. The display device with the touch panel according to claim 1, wherein the damage-protection coating layer has a hardness harder than that of the rough-surfaced coating layer.

3. The display device with the touch panel according to claim 1, wherein both of the rough-surfaced coating film and the damage-protection coating layer have hardness 3 H in accordance with the Japanese Industrial Standard.

4. The display device with the touch panel according to claim 1, wherein the rough-surfaced coating layer serves as a glare proof coating layer in which the micro-roughed surface diffusively reflects incident light entering into the display.

5. A method for manufacturing a display device with a touch panel that has a display having a surface on which the touch panel is provided, wherein in the touch panel transparent conductive layers are oppositely arranged each other to form a contact, comprising steps of:
providing a rough-surfaced coating layer on the display and forms a micro-roughed surface;
providing a damage-protection coating layer on the bottom surface of the touch panel, the damage-protection coating layer having almost the same hardness with the rough-surfaced coating layer; and
laminating the touch panel onto the surface of the display so that the rough-surfaced coating layer and the damage-protection coating layer are in contact with each other.

6. The display device with the touch panel according to claim 2, wherein both of the rough-surfaced coating film and the damage-protection coating layer have hardness 3 H in accordance with the Japanese Industrial Standard.

7. The display device with the touch panel according to claim 2, wherein the rough-surfaced coating layer serves as a glare proof coating layer in which the micro-roughed surface diffusively reflects incident light entering into the display.

8. The display device with the touch panel according to claim 3, wherein the rough-surfaced coating layer serves as a glare proof coating layer in which the micro-roughed surface diffusively reflects incident light entering into the display.
